(19) United States
(12) Patent Application Publication
(10) Pub. No.: US 2005/0265717 A1
(43) Pub. Date: Dec. 1, 2005

(54) Opto-electronic device testing apparatus and method

(76) Inventor: Yu Zhou, Singapore (SG)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/857,193

(22) Filed: May 28, 2004

(51) Int. Cl. H04B 10/08

(52) U.S. Cl. 398/9

(57) ABSTRACT

A testing apparatus and method for obtaining a parameter of an opto-electronic device under test (DUT). The apparatus includes a reference device from which at least one calibration value has been obtained and a storage medium for storing the at least one calibration value. The method includes optically coupling the reference device to the DUT. A light signal is caused to propagate between the reference device and the DUT to cause an output signal to be generated that provides the desired parameter according to the stored at least one calibration value.

### BACKGROUND

This invention relates to a testing apparatus and a testing method for obtaining an opto-electronic parameter of an opto-electronic device, and more particularly, to a testing apparatus and a testing method for obtaining a set of opto-electronic parameters for each of a multiple of opto-electronic transceivers at different operating temperatures.

With optical systems, such as the passive optical network (PON), gaining popularity, opto-electronic devices such as opto-electronic transceivers, transmitters and receivers used in such optical systems are also becoming more important. To reduce the maintenance cost of such systems, the system manufacturer expects the opto-electronic devices used therein to be free of defects and to perform according to their specifications. For example, it is typically required that every transceiver for use in a system be subjected to rigorous testing prior to being shipped to the system manufacturer. Tests are carried out at different temperatures across a wide temperature range, for example −10° C. to +85° C.

According to a known method of testing, each transceiver is subjected to two tests—an initial power-on test (also referred to as an “oven test”) and a subsequent over-temperature test. In the oven test, multiple transceivers are tested simultaneously in a temperature control chamber wherein the temperature is set at 75° C. Prior to oven testing, the transmitter output of each of the transceivers is connected to its respective receiver input to form a looped-back connection. The transmitter of each transceiver is configured to transmit a test signal across its respective loop-back connection to thereby exercise the transceiver. A light-emitting-diode (LED) associated with each transceiver is turned on if its receiver is able to successfully receive the test signal. An output signal of each transceiver is monitored to determine such a condition. This output signal is the Signal-Detect (SD) output for pin-through-hole type of transceivers and the Loss-of-Signal (LOS) output for small form pluggable (SFP) type of transceivers, which should be at a logical high and a logical low level respectively when the transceiver is functioning properly. This oven test screens for functional, shutdown, laser infant and short-circuit failures in the transceivers. The transceivers that pass the oven test are removed from the chamber and individually subjected to the over-temperature test.

The test equipment used for the over-temperature test, as shown in FIG. 1, includes a thermal stream generator. The test equipment also includes several test and measurement instruments that are mounted on a rack. The test and measurement instruments include a digital communication analyzer (DCA), a bit error rate tester (BERT), a digital multimeter, an optical attenuator, all of which are connected to a host computer. A light source is connected to the optical attenuator for generating a light signal that is appropriately attenuated using the optical attenuator. The host computer sends a control message, which specifies the desired intensity or power of a light signal to the optical attenuator. The optical attenuator then adjusts the attenuation of the light signal from the light source accordingly to obtain a light signal of a desired light power. To perform the over-temperature test, the instruments are directly connected to a single transceiver under test for obtaining several opto-electronic parameters of the transceiver. The thermal generator is adjusted to deliver thermal streams of different temperatures at the transceiver under test so that the opto-electronic parameters can be obtained at those temperatures. The measured parameters are compared to respective limits in the host computer to determine if the transceiver under test is functioning according to specification.

Although the above-described testing method works, it nevertheless suffers a variety of drawbacks. The thermal stream generator can only be used for heating one transceiver at a time. To test the transceiver, the thermal stream is set at a first temperature of a set of testing temperatures. The transceiver is soaked at that temperature for a predetermined period before its parameters are obtained at that temperature. After the parameters are obtained, the temperature of the thermal stream is ramped up to the next higher temperature for the transceiver to be soaked thereat for another predetermined period before the parameters are obtained again. The process is repeated for each of the set of testing temperatures. Since, substantial time is required for raising the temperature of the thermal stream, the testing throughput for a set of test equipment, measured in units-per-hour (UPH), is low, typically of a single digit value.

To increase the testing throughput, more sets of thermal streams and associated instruments are required. However, the cost of a set of thermal stream and instruments, which may be as much as U.S.$150,000 or more in total, is prohibitively high.

The problem is exacerbated by the need for equipment, such as fiber optic cables and connectors, which are specific for testing each type of transceivers. With transceivers classified as single mode (operating at a particular wavelength) or multimode transceivers (operating at several different wavelengths) and further classified according to their data rate or speed, different sets of testing equipment are usually provided. The provision of different configurations of testing equipment is not cost effective.

Moreover, special power lines and compressed air pipes are required for operation of the thermal stream generators. The installation of these power lines and compressed air pipes further adds to the cost.

### SUMMARY

The invention may be implemented as a cost-effective testing apparatus for obtaining a parameter of an opto-electronic device under test (DUT). The apparatus includes a reference device from which at least one calibration value has been obtained and a storage medium for storing the at least one calibration value. During testing, the reference device is optically coupled to the DUT. A light signal is caused to propagate between the reference device and the DUT to cause an output signal to be generated that provides the desired parameter according to the stored at least one calibration value.

According to another implementation of the invention, there is provided a method for obtaining at least one parameter of at least one opto-electronic device under test (DUT). The method includes calibrating at least one reference device to obtain at least one calibration value and storing the at least one calibration value in a storage medium. To obtain a parameter of the DUT, the DUT is coupled to the reference device. If the parameter is a receiver parameter, the reference device is configured using one of the at least one calibration value to transmit a light signal of a corresponding known power level to the DUT. An output signal of the DUT is then measured to obtain the receiver parameter. If the parameter is however a transmitter parameter, the DUT is configured to transmit a predetermined light signal to the reference device instead. In this case, an output signal of the reference device is measured and the transmitter parameter is obtained from the at least one calibration value based on the measurement.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a schematic drawing of a prior art testing equipment for testing an opto-electronic transceiver;

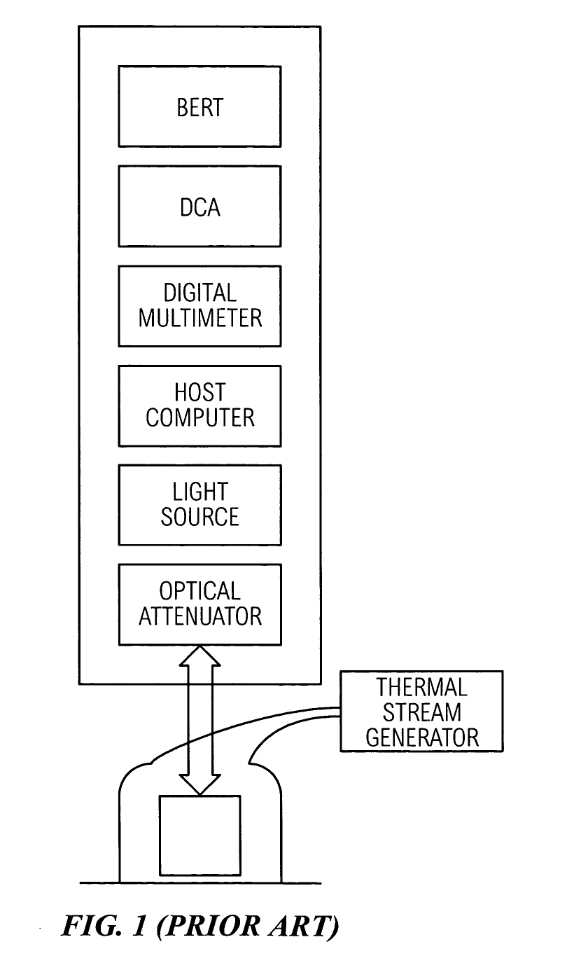

FIG. 2 is a schematic drawing of a testing apparatus according to an embodiment of the invention;

FIG. 3 is a schematic drawing similar to FIG. 2 showing in detail some of the electrical signal lines connecting the various components of the testing apparatus in FIG. 2;

FIG. 4 is a schematic drawing of a daughter board of the testing apparatus in FIG. 2;

FIG. 5 is a flowchart showing a method for testing multiple transceivers, according to an embodiment of the invention, using the apparatus in FIG. 2; and

FIG. 6 is a schematic drawing of an alternative printed circuit board on which reference transceivers and transceivers under test may be mounted for testing.

### DETAILED DESCRIPTION OF THE EMBODIMENTS

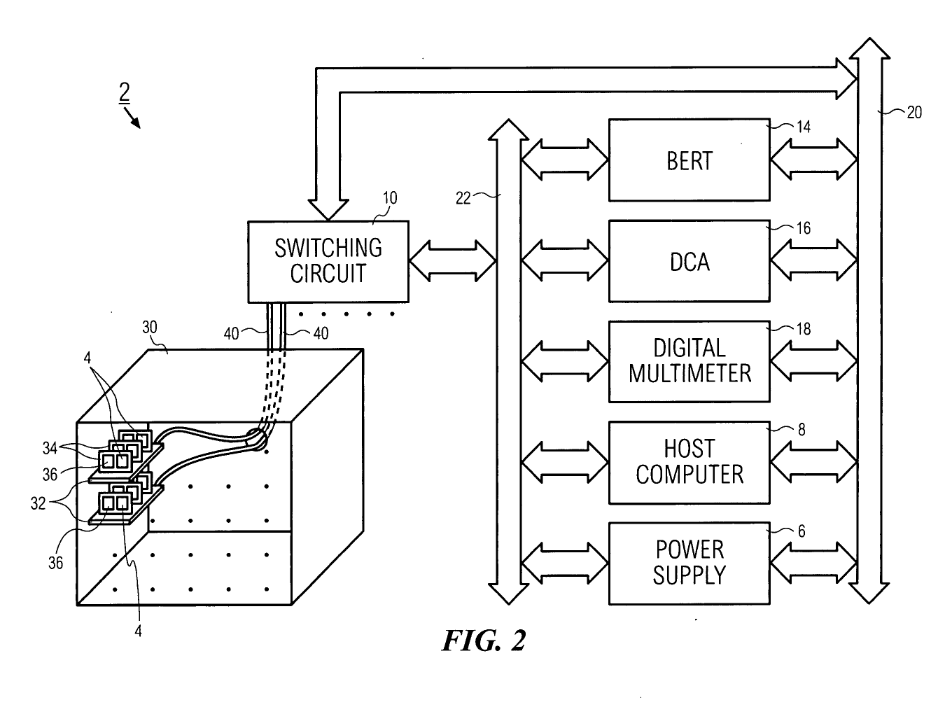

As shown in the drawings for purposes of illustration, the invention is embodied in a novel testing apparatus and method for testing multiple opto-electronic devices such as transceivers, transmitters and receivers. Existing apparatus and methods have suffered from high equipment cost and low throughput. Referring to FIG. 2, a testing apparatus embodying the invention obtains at least a parameter of an opto-electronic device under test (DUT) 4. Generally, the apparatus includes a reference device 36 from which at least one calibration value has been obtained and a storage medium (not shown) for storing the at least one calibration value. This reference device 36 is optically coupleable to the DUT 4 whereby a light signal can be caused to propagate between the reference device 36 and the DUT 4 and generate an output signal that provides the desired parameter according to the stored at least one calibration value.

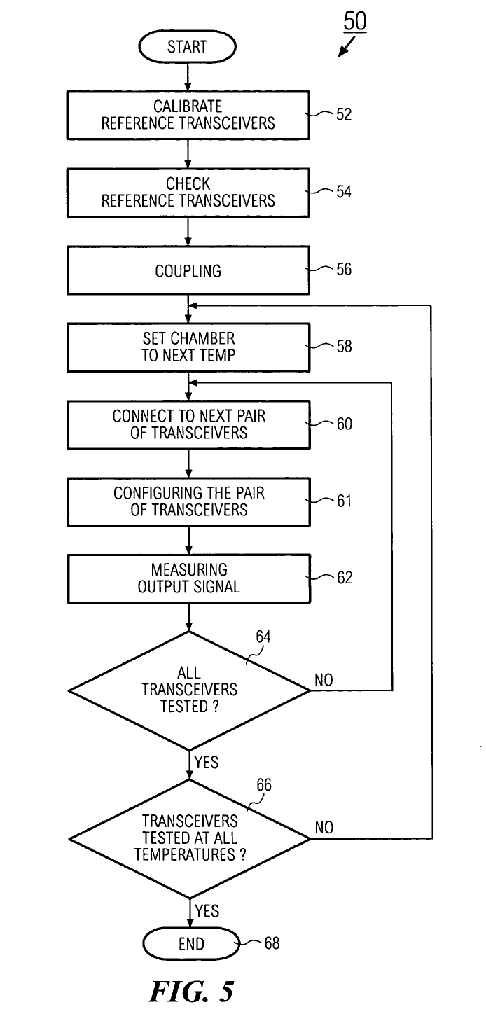

Referring to FIG. 5, a method 50 generally for obtaining at least one parameter of at least one DUT 4 includes calibrating 52 at least one reference device 36 to obtain at least one calibration value. The calibration value is stored in a storage medium. During testing, the DUT 4 is coupled 56 to the reference device 36. If the parameter is a receiver parameter of a receiver or a transceiver, the method further includes configuring 61 the reference device 36 using the at least one calibration value to transmit a light signal of a corresponding known power level to the DUT 4 and measuring 62 an output signal of the DUT 4 to obtain the receiver parameter. If the parameter is however a transmitter parameter of a transmitter or a transceiver, the method further includes configuring 61 the DUT 4 to transmit a predetermined light signal to the reference device and measuring 62 an output signal of the reference device 36 and obtaining the transmitter parameter from the at least one calibration value based on the measurement.

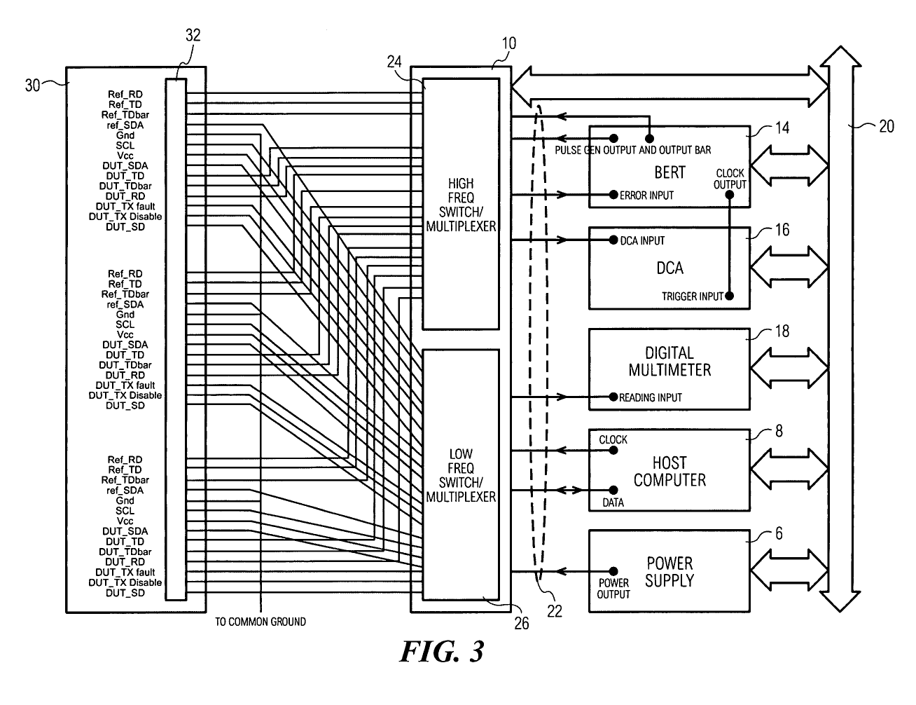

Referring again to FIGS. 2 and 3, a testing apparatus 2 according to one embodiment of the invention for testing multiple opto-electronic transceivers 4 includes a power supply 6, a processor or host computer 8, a switching circuit 10, and a set of test and measurement instruments. The set of test and measurement instruments includes a bit error rate tester (BERT) 14, a digital communication analyzer (DCA) 16, and a digital multimeter 18. It should be understood that not all instruments 14, 16, 18 are necessary; only those relevant to measurement of the parameters to be obtained need to be used. For example if only one parameter is to be obtained, only the relevant instrument is used. These instruments 14, 16, 18, the power supply 6 and the switching circuit 10 are communicatively coupled to the host computer 8 via a general-purpose interface bus (GPIB) 20 to be thereby controlled by the host computer 8. The BERT 14 has a clock output port (FIG. 3) that is connected to a trigger input port of the DCA 16.

The instruments 14, 16, 18, power supply 6 and host computer 8 are connected to the switching circuit 10 via a test bus 22 that includes high frequency and low frequency signal lines. The high frequency signal lines are connected to a high-frequency switch 24 of the switching circuit 10 while the low frequency signal lines are connected to a low-frequency switch 26 of the switching circuit 10. As shown in FIG. 3, the high frequency signal lines of the test bus 22 include a pulse generator output signal line, a pulse generator output bar signal line and an error input signal line of the BERT 14, and an input signal line of the DCA 16. The low frequency signal lines of the test bus 22 include an input signal line of the digital multimeter 18, a power supply line of the power supply 6 and the host computer's clock output signal line and bidirectional data signal line. The clock and data signal lines are connected to the serial clock (Mod_Def2) and data (Mod_Def1) pins of the transceivers 36, 4 respectively.

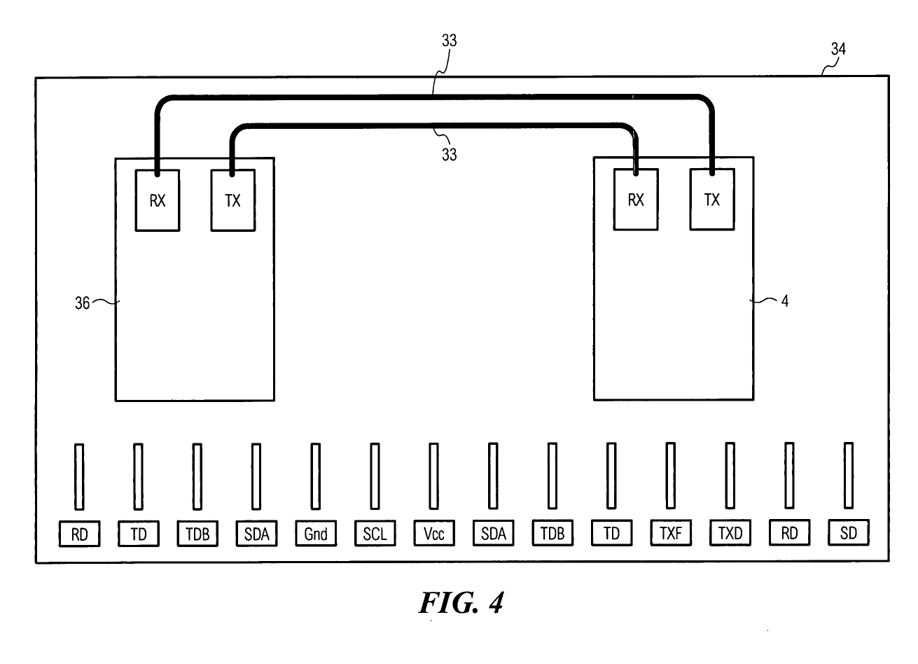

The testing apparatus 2 further includes a temperature control chamber 30 and multiple mother boards 32 (two of which are shown in FIG. 2) and daughter boards 34, one of which is also shown in detail in FIG. 4. Several daughter boards 34 are removably mountable on each mother board 32. The mother boards 32 are removably installable in the chamber 30 to be housed therein. Signal lines on the mother boards are connected to the instruments 14, 16, 18 via the switching circuit 10. On each daughter board 34 is a reference transceiver 36 and a socket (not shown) for receiving one of the DUTs 4 to be tested. When received in the socket, the DUT 4 to be tested is coupled to the reference transceiver 36 by connecting a transmitter output and a receiver input of the reference transceiver 36 to the receiver input and the transmitter output of the DUT 4 respectively using fiber optic cables 33 which have a fixed attenuation factor of, for example, 17 dB that are appropriate for the type of the transceivers 4, 36. The reference transceiver 36 is at least substantially of the same type as the DUT 4. In other words, the reference transceiver 36 should have the same wavelength as the transceiver 4 to be tested and it should support the data rate at which the DUT 4 operates. One of the functions of the reference transceiver 36 is to act as a light source for transmitting a light signal to the DUT 4. The reference transceiver 36 may be fixedly mounted on the daughter board 34 or plugged onto another socket (not shown) on the daughter board 34. The pins of each pair of reference transceiver 36 and DUT 4 are connected via electrical traces (not shown) on the daughter board 34 and the mother board 32, and wires in a cable 40 to the switching circuit 10 located outside the chamber 30. The cable 40 carries only electrical signals. Specifically, the following pins of each transceiver 36, 4 pair are connected to respective ports of the high-frequency switch 24 of the switching circuit 10:

| | |
|---|---|
| Ref_RD | Receiver Data (output) of the reference transceiver 36 |
| Ref_TD | Transmitter Data (input) of the reference transceiver 36 |
| Ref_TDbar | Transmitter Data bar (input) of the reference transceiver |
| | 36 |
| DUT_RD | Receiver Data (output) of the DUT 4 |
| DUT_TD | Transmitter Data (input) of the DUT 4 |
| DUT_TDbar | Transmitter Data bar (input) of the DUT 4 |

The following pins of the transceiver 36, 4 pair are connected to the low-frequency switch 26 of the switching circuit 10:

| | |
|---|---|
| Vcc and DUT 4 | Supply voltage (input) to both the reference |
| | transceiver 36 |
| SCL DUT 4 | Serial Clock (input) of the reference |
| | transceiver 36 and |
| Ref_SDA | Serial Data (output) of the reference |
| | transceiver 36 |
| DUT_SDA | Serial Data (output) of the DUT 4 |
| DUT_TX fault | Transceiver fault (output) of the DUT 4 |
| DUT_TX Disable | Transceiver disable (input) of the DUT 4 |
| DUT_SD/LOS | Signal detect/loss of signal (output) of the |
| | DUT 4. |

The switching circuit 10 is configurable by the host computer 8 via the GPIB 20 to connect test signals of the test bus 22 to the respective pins of a pair of transceivers 36, 4 selected by the host computer 8. In other words, the host computer 8 is able to selectively connect the instruments 14, 16, 18 and power supply 6 to a selected pair of reference transceiver 36 and DUT 4.

Each reference transceiver 36 is calibrated 52 (FIG. 5) so as to obtain calibration values thereof at each test temperature. The calibration values are stored in a storage medium (not shown) according to the device identity (ID) of the reference transceiver 36. The device ID of the reference transceiver 36 is readable from the reference transceiver 36 via its serial data output (Ref_SDA). The storage medium may be a floppy disk, a compact disk, a hard drive or other suitable host computer 8 readable storage medium. The calibrated values include a set of bias current (I_{bias}) configuration values for setting a bias current (I_{bias}) of the reference transceiver 36 to thereby cause the reference transceiver 36 to generate light signals at known power levels corresponding to the bias current configuration values. To obtain these bias current configuration values corresponding to a set of transmitted light output power levels, the bias current is adjusted by changing the bias current configuration values until the light output power levels are attained at the transmitter output of the reference transceiver 36. These bias current configuration values are recorded and stored in the storage medium for each reference transceiver 36.

In addition to obtaining the bias current configuration values for the reference transceiver 36 at each testing temperature, a corresponding set of modulation current for each of the reference transceivers 36 is also obtained. Each modulation current configuration value corresponds to a bias current configuration value. This modulation current configuration value is used to set the modulation current of the respective reference transceiver 36 such that the transmitted light at a power level corresponding to the bias current is maintained at least substantially at a predetermined extinction ratio (ER), for example at 9 dB, according to some transceiver specifications.

A receiver of each reference transceiver 36 is also calibrated to obtain bit error rate (BER) values that correspond to light signals received by the receiver at known power levels. To obtain these BER values, the receiver input of the reference transceiver 36 is connected to, for example, the pulse generator outputs of the BERT 14 which provides a light signal modulated by a pulse generator (not shown) of the BERT 14; and the receiver data output (Ref_RD) of the reference transceiver 36 is connected to the input of the error detector of the BERT 14. The power level of the input light signal is adjusted until selected BERs are obtained. The extinction ratio of the input light signal is kept at a default value specified for the reference transceiver 36. The power levels and corresponding BERs of the reference transceiver 36 are recorded and stored in the storage medium.

In this manner, the reference transceivers 36 are each calibrated 52 to obtain a set of temperature-dependent opto-electronic calibration values to allow each reference transceiver 36 to be able to transmit a light signal at a known power level to a DUT 4 or to receive a light signal whose power level is determinable based on the calibration values.

Each reference transceiver 36 is also able to determine the optical modulation amplitude (OMA) of a light signal received by the reference transceiver 36. This OMA is readable from the reference transceiver 36 via its serial data output (Ref_SDA).

Referring once again to FIG. 5, a method, according to an embodiment of the invention for testing of multiple transceivers 4 using the testing apparatus 2 includes calibrating 52 multiple reference transceivers 36 to obtain respective calibration values as described above. In some embodiments, when using these reference transceivers, the method includes checking 54 the parameters of a number of the reference transceivers 36 against their respective calibration values obtained during calibration 52. Those reference transceivers 36 whose parameters remain consistent with those obtained during calibration 52 are then selected and mounted on respective daughter boards 34. Next the transceivers 4 to be tested (DUT) are coupled 56 to the selected reference transceivers 36 on their respective daughter boards 34. These reference transceiver 36 and DUT 4 pairs are placed in the temperature control chamber 30. To proceed with testing, a test program is then run on the host computer 8. An operator of the testing apparatus is prompted by the host computer 8 to set 58 the temperature of the chamber 30 to a first predetermined temperature of a set of test temperatures (for example, −10° C., +25° C. and +85° C.) and to allow the transceivers 36, 4 in the chamber 30 to soak thereat for a predetermined soaking period. After the transceivers 36, 4 have been soaked for the predetermined soaking period, the host computer 8 sends a command to the switching circuit 10 to cause it to connect 60 the set of test instruments 14, 16, 18, the power supply 6 and a serial communication link, defined by the clock and the data lines of the host computer 8 to a next pair of transceivers 36, 4. The connection details will be described later.

A series of tests is next performed using the test instruments 14, 16, 18 under the control of the host computer 8. The tests involve configuring 61 one of the reference devices 36 and the DUT 4 to cause a light signal to propagate therebetween, and generate an output signal which is measured 62. The manner in which some of these tests are carried out will also be described in more details later. A parameter is obtained for each test. To obtain a receiver parameter of the DUT 4, the reference transceiver 36 is configured 61 using one of the calibration values to transmit a light signal of a selected power level to the DUT 4. The host computer obtains the configuration values of the particular reference transceiver 36 and transmits it to that reference transceiver 36 to configure 61 the reference transceiver 36. The host computer 8 transmits the configuration values by configuring the switching circuit 10 to connect the clock and data signal lines of the host computer 8 to the serial clock (Mod_Def1) and data (Mod_Def2) of the reference transceiver 36. An output signal of the DUT 4 is then measured 62 to obtain the parameter.

To obtain a transmitter parameter of the DUT 4, the DUT 4 is configured 61 to transmit a predetermined light signal to the reference transceiver 36. Similarly, an output signal of the reference transceiver 36 is measured 62 and the transmitter parameter of the DUT 4 is obtained from the calibration values based on the measurement. In other words, the transmitter parameter is obtained from the measured output according to the at least one calibration value associated with the reference device 36. After each parameter is obtained, the host computer 8 compares the parameter with corresponding acceptable limits stored on the host computer 8 to determine whether the DUT 4 passes or fails this particular test. The host computer 8 records the obtained parameter in a file and displays the parameter on a screen of the host computer 8.

After the measurements for the DUT 4 are obtained, the host computer 8 determines 64 if all DUTs 4 for testing at the first predetermined temperature have been tested. If it is determined that there are further DUTs 4 for testing, the host computer 8 once again sends a command to the switching circuit 10 to cause it to connect 60 the set of test instruments 14, 16, 18, the power supply 6 and the serial communication link of the host computer 8 to a next pair of transceivers 36, 4. A set of measurements is then similarly obtained for this next pair of transceivers 36, 4. In this manner, the host computer 8 sequentially connects 60 the instruments 14, 16, 18 to each pair of reference transceiver 36 and associated DUT 4 to obtain the parameters of that DUT 4 at the predetermined temperature. It should be noted that light signals from the reference devices 36 for obtaining a same receiver parameter of the associated DUTs 4 have substantially the same known power level.

If it is determined 64 that all DUTs 4 for testing at the temperature have been tested, the host computer 8 determines 66 if the DUTs 4 have been tested at all test temperatures. If it is determined 66 that there are further temperatures at which the DUTs 4 are to be tested, the temperature of the chamber 30 is set to a next test temperature and the host computer 8 sequentially connects 60 the instruments 14, 16, 18 to each pair of reference transceiver 36 and associated DUT 4 to obtain 61, 62 the parameters of that DUT 4 at the predetermined temperature until it is determined that all the DUTs 4 have been tested at all predetermined test temperatures. The testing ends 68 with the host computer 8 printing a summary which contains the serial numbers of all the DUTs 4 that are tested, the parameters of these DUTs 4 and the corresponding pass or fail results.

Some of the tests performed on a DUT 4 connected to a particular reference transceiver 36 are described next. All of these parameters associated with the tests are known to those skilled in the art and thus will only be briefly described. Those skilled in the art should appreciate that any reference to connecting a test signal to a pin of the transceiver 36, 4, hereafter would require appropriate configuration of the switching circuit 10 by the host computer 8 to effect the connection. Also, those skilled in the art would appreciate that the transmit data inputs to the transceivers 36, 4 (Ref_TD, Ref_TDbar, DUT_TD, and DUT_TDbar) are connected to the pulse generator output and output bar of the BERT 14 to receive a test signal therefrom when the respective transceiver 36, 4 is configured to transmit a light signal.

One of the DUT parameters that can be obtained is the “receiver signal detect voltage level” at a particular light input power level. To obtain this “receiver signal detect voltage level”, the host computer 8 obtains the bias current configuration value of the reference transceiver 36 corresponding to the power level. The host computer 8 configures 61 the reference transceiver 36 by setting a DAC value within the reference transceiver 36 using the obtained bias current configuration value so that a light signal at the required power level is generated at the transmitter output of the reference transceiver 36. This light signal is received by the DUT 4 at its receiver input. The signal detect/loss of signal output (DUT_SD/LOS) of the DUT 4 is connected to the input line of the multimeter 18. The amplitude of the signal at this DUT_SD/LOS output as measured 62 by the multimeter is the “receiver signal detect voltage level”. The “receiver signal detect voltage levels” for input light at other power levels, if required, may be similarly obtained.

Another two DUT 4 parameters that can be obtained using the test apparatus 2 are the “receiver power assert” and the “receiver power deassert” levels. These parameters are obtained by configuring 61 the reference transceiver 36 so that its output power level is set to appropriate levels using the corresponding bias current configuration values for the reference transceiver 36. The signals at the signal detect/loss of signal output (DUT_SD/LOS) are measured 62 using the multimeter 18 as described above. For SFF type transceivers 4, the “receiver power assert” parameter is the power level of the light output of the reference transceiver 36 which causes the DUT_SD/LOS output to switch from a logic low (for example less than 0.8 V) to a logic high level (for example above 2.0 V); and the “receiver power deassert” parameter is the power level of the light output of the reference transceiver 36 which causes the DUT_SD/LOS output to switch from a logic high to a logic low level. For SFP type transceivers 4, the “receiver power assert” is the power level of the light output of the reference transceiver 36 which causes the DUT_SD/LOS output to switch from a logic high to a logic low level; and the “power deassert” parameter is the power level of the light output of the reference transceiver 36 which causes the DUT_SD/LOS output to switch from a logic low to a logic high level.

Yet another transceiver parameter that can be obtained is the “receiver data swing” and the “receiver data bar swing”. To obtain these parameters, the reference transceiver 36 is again configured 61 using the bias current configuration values to output light signals at power levels necessary for determining the parameters. The receiver data output (DUT_RD) is connected to the DCA input of the DCA 16. A built-in function of the DCA 16 measures 62 and analyzes the signal at the DUT_RD output to provide these parameters. Alternatively, the receiver data bar output (DUT_RDB) may also be connected to the DCA input instead of the DUT_RD to obtain the parameters.

A further DUT 4 parameter that can be obtained is the “receiver center sensitivity”. To obtain the “receiver centre sensitivity”, the receiver data (DUT_RD) output of the DUT 4 is connected to the error input of the error detector of the BERT 14. The power level and extinction ratio at that power level of the light output of the reference transceiver 36 is then adjusted by configuring 61 the reference transceiver 36 to change its bias current and modulation current respectively until the bit error rates (BERs) as measured 62 by the error detector are for example of 1E-6, 1E-7, 1E-8. The power levels that result in these BERs are the “receiver centre sensitivities” at those BERs. It may be sufficient for example to obtain the “receiver center sensitivities” at these higher BERs directly and to obtain the “receiver center sensitivity” at a lower BER through extrapolation using the former to reduce measurement time. Although it is possible to directly obtain the “receiver centre sensitivity” at any particular BER directly using the above method, it takes a longer time to register a lower BER and thus to obtain the corresponding “receiver centre sensitivity.”

Another DUT 4 parameter is the level of the “transmitter light output power” (LOP). To obtain the level of the LOP of the DUT 4, the receiver data output (Ref_RD) of the reference transceiver 36 is connected to the error input of the error detector of the BERT 14 for measuring 62 the BER of a light signal received by the reference transceiver 36. The DUT 4 is configured 61 to transmit a light output signal that is received by the reference transceiver 36. Assuming that the extinction ratio of this light output signal does not change, the measured light output power of the DUT 4 is obtained from the BER recorded by the BERT 14. The absolute LOP of the DUT 4 can then be determined by subtracting the loss of the connecting fiber optic cable 33 from the measured LOP.

Another DUT 4 parameter that can be obtained is the “transmitter optical modulation amplitude” (OMA). Since the transmitter output of the DUT 4 is directly connected to the receiver input of the reference transceiver 36, the transmitter OMA of the DUT 4 can be obtained by reading the receiver OMA of the reference transceiver 36 directly via its serial data output (Ref_SDA).

The transmitter extinction ratio (ER) of the DUT 4 can be determined from its LOP and OMA based on the following equation:

$$OMA = \frac{2 LOP ( ER - 1 )}{( ER + 1 )}$$

Another two DUT 4 parameters that can be obtained are the “transmitter fault high” and “transmitter fault low” parameters. These parameters can be obtained by connecting the transmitter fault output (DUT_TX fault) of the DUT 4 to the multimeter 16 to be measured 62 thereby, toggling the power supply to the DUT 4 between two predetermined levels and obtaining the readings from the multimeter for each of the two levels. The readings constitute the “transmitter fault high” and “transmitter fault low” parameters.

The transmitter disable function can also be verified using the reference transceiver 36. To do so, the transmitter disable (DUT_TX disable) input is connected to the power supply. The transmitter of the DUT 4 is activated and the output of the power supply is toggled to vary the supply voltage to the DUT 4. The receiver OMA of the reference transceiver 36 is then read to determine if the transmitter disable function of the DUT 4 works according to the specifications.

The following is a tabulation of parameters of a DUT 4 measured using the prior art method and that according to the embodiment of the invention as described above.

| | | | Data obtained using | | | |
|---|---|---|---|---|---|---|
| | | | Testing apparatus | | Absolute | |
| | Data obtained | | according to | | Error | Tester |
| | using Prior Art | | embodiment of | | between | Repeata- |
| Parameter | Tester | | invention | | the data | bility |
| RX LOS | 3.19 | V | 3.21 | V | 0.02 | 0.001 |
| High | | | | | | |
| RX LOS | 0.41 | V | 0.41 | V | 0 | 0 |
| Low | | | | | | |
| RX Power | −22.35 | dBm | −22.54 | dBm | 0.19 | 0.35 |
| Assert | | | | | | |
| RX Power | −25.72 | dBm | −25.91 | dBm | 0.19 | 0.35 |
| Deassert | | | | | | |
| RX | −21.15 | dBm | −21.52 | dBm | 0.37 | 0.34 |
| Sensitivity | | | | | | |
| TX LOP | −3.37 | dBm | −3.42 | dBm | 0.05 | 0.459 |
| TX ER | 10.13 | dB | 10.62 | dB | 0.49 | 0.425 |
| OMA | 747.35 | uW | 765.06 | uW | 17.71 | 44.78 |

As can be seen from the above data, the parameters obtained using both methods are quite close in values.

For a mother board 32 supporting three daughter boards 34, each of which has two transceivers mounted thereon as shown in FIG. 2, the total pin count of the motherboard 32 for connecting it to the switching circuit 10 is eighty-four. Such a high pin count limits the number of transceiver 36, 4 pairs that can be mounted on each mother board 32.

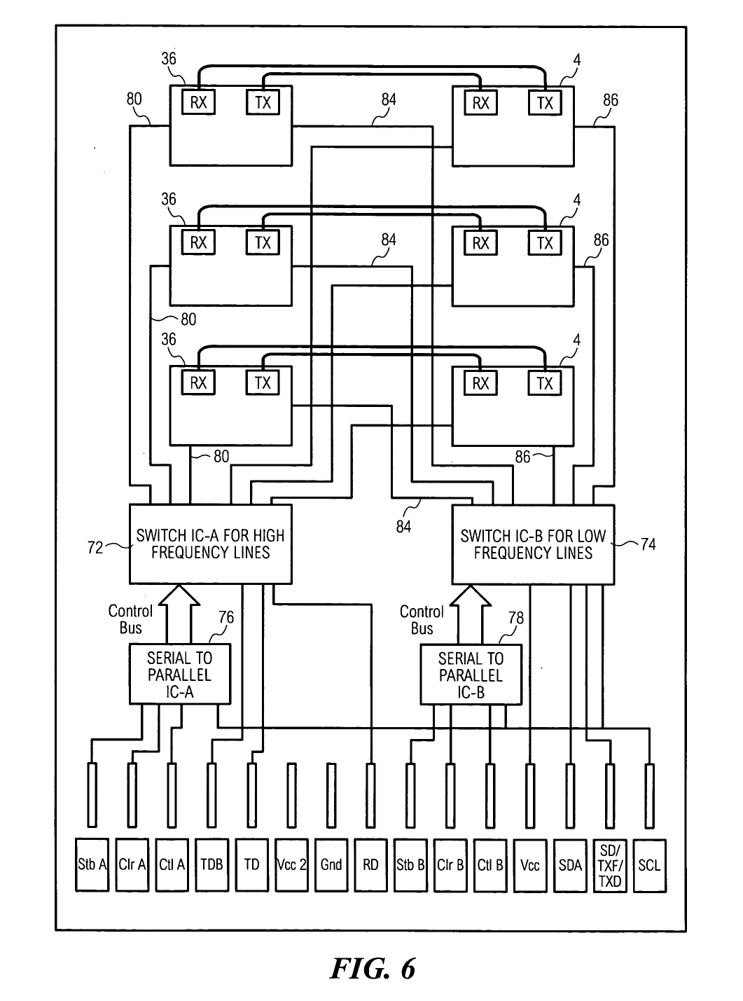

FIG. 6 is a schematic drawing of an alternative printed circuit board 70 (PCB) on which the reference transceivers 36 and the DUTs 4 may be mounted. With such a PCB 70, the earlier described daughter boards and sockets for receiving them are no longer required; the sockets for both types of transceivers, i.e. pin through hole and pluggable (SFP) types, can be directly mounted onto the PCB 70. The PCB 70 may be appropriately sized to accommodate several reference transceiver 36 and associated DUT 4 pairs. Additionally, a high frequency (HF) switch 72, a low frequency (LF) switch 74, and two serial to parallel converters 76, 78 are mounted on the PCB 70. The PCB 70 is connected directly to the test bus 22 shown in FIG. 3. The high frequency lines and low frequency lines of the test bus 22 are connected to the HF switch 72 and the LF switch 74 respectively.

The serial data input and clock pins of the serial to parallel converters 76, 78 are connected to two data signal lines (one of which is shown in FIG. 3) and the clock output signal line of the host computer 8 respectively. The host computer 8 sends serial data to the serial to parallel converters 76, 78. The serial to parallel converters 76, 78 converts the serial data to parallel data for controlling the HF and LF switches 72, 74. An example of a serial to parallel converter is the BU2152FS serial to parallel converter IC from Rohm Co., Ltd. The strobe and clear pins of such an IC are connected to respective pins (not shown) of the host computer 8.

The pins, Ref_RD, Ref_TD and Ref_TDbar signals (shown collectively as a bus 80) of each reference transceiver 36 and DUT_RD, DUT_TD, and DUT_TDbar signals (shown collectively as a bus 82) of each DUT 4, are connected to the respective ports of the HF switch 72. The HF switch 72 is configurable by the host computer 8 via the serial to parallel converter 76 to connect the high frequency test signals of the test bus 22 to the respective pins of either a reference transceiver 36 or an associated DUT 4. In other words, the host computer 8 is able to selectively connect the BERT 14 and DCA 16 to either a reference transceiver 36 or to a DUT 4. An example of a HF switch 72 is a high data rate cross-point switch such as the NJU 7370 8×32 analog cross point switch available from New Japan Radio Co., Ltd. The number of high data rate cross-point switches required on the PCB 70 depends on the number of reference transceiver 36 and DUT 4 pairs and the number of ports available on each cross-point switch.

The pins SCL, Ref_SDA (collectively shown as a bus 84) of each reference transceiver 36 and SCL, DUT_SDA, DUT_TX fault, and DUT_TX disable (collectively shown as a bus 86) of each DUT 4, are connected to the respective ports of the LF switch 74. The LF switch 74 is configurable by the host computer 8 via the serial to parallel converter 78 to connect the low frequency test signals of the test bus 22 to the respective pins of either the reference transceiver 36 or an associated DUT 4. In other words, the host computer 8 is able to selectively connect the multimeter 18 and power supply 6 to a selected DUT 4. The host computer 8 is also able to selectively connect its data and clock signals to the selected DUT 4 or a reference transceiver 36. The number of LF switches 74 required on the PCB 70 depends on the number of reference transceiver 36 and DUT 4 pairs and the number of ports available on each LF switch 74. Examples of a LF switch 74 are typical cross-point switches and multiplexers.

With such a PCB 70, the number of pins required for connecting the PCB to the test bus 22 is drastically reduced to eleven, including a second power supply line Vcc2 and a ground signal line.

Advantageously, the testing method using the testing apparatus 2 that embodies the invention results in a high UPH for over temperature test. With the testing method, the DUTs 4 can also be over-temperature tested in a temperature control chamber that was previously used only for oven testing. In other words, oven test and over temperature test can be performed simultaneously.

Although the parameters of only one DUT 4 can be obtained at any one time with one set of test and measurement instruments, the simultaneous heating and soaking of the DUTs 4 in the temperature control chamber 30 allows the UPH of the testing apparatus to exceed that achievable in the prior art wherein DUTs 4 are heated to different temperatures and soaked thereat individually. If the total time taken to completely test one DUT 4 is one and a half minutes, it will take a mere total of one hundred and fifty minutes, inclusive of temperature ramping time, to complete the testing of all one hundred DUTs 4 at a particular temperature. If a second set of test and measurement instruments are available, the total testing time for the one hundred transceivers will be halved to about seventy-five minutes. In this time, both the oven test and final module-over-temperature test are completed. The oven test in this case is performed by configuring or biasing all the reference transceivers 36 and DUTs 4 in the temperature chamber 30 and leaving them powered on while the over-temperature test is carried out for each DUT 4. Consequently, the UPH of the testing system is easily determinable and controllable. More importantly, the UPH, which may be of several hundred transceivers with the provision of an appropriate number of sets of test and measurement instruments is high compared with single-digit UPH achievable with each prior art test system.

Since the oven test is performed for all DUTs 4 in the prior art, the testing method does not appear to depart too significantly from the prior art oven test to an operator performing the prior art oven test. Thus, only minimal training is required for the operator to switch to the new testing method.

Furthermore, since less equipment and operators are required for the testing method, the equipment and human cost involved in testing is significantly reduced.

This testing system is also versatile in the sense that it can be used to test both small-form pluggable (SFP) and pin-through-hole versions of single-mode and multi-mode DUTs 4 of different speeds without changing the test setup. Since use of DUT specific equipment is restricted to its connection to the reference transceiver 36, simultaneous testing of different types of transceivers in the temperature control chamber 30 is possible. In other words, only respective fiber optic cables are required to be selected for connecting a reference transceiver 36 to its associated DUT 4; no change of other equipment is required.

Although the invention is described as implemented in the above-described embodiment wherein a reference transceiver 36 is coupled to a DUT 4, it is not to be construed to be limited as such. For example, a reference opto-electronic device may be connected to another opto-electronic device to be tested. The reference device 36 may be a reference transmitter or a reference receiver, in which case, the DUT 4 may be a receiver or a transmitter respectively.

In some embodiments, the reference transceivers 36 may also be placed outside of the temperature control chamber 30. In such a case, the reference transceivers 36 may only need to be calibrated at a single temperature.

In other embodiments, if the DUTs are all of a single type, only one single reference transceiver 36 is necessary for testing the DUTs 4. This single reference transceiver 36 may then be connected, in turn, to each of the DUTs 4 located in the temperature chamber 30. The connection includes transmission of optical signals, which requires an optical switch or demultiplexer to be incorporated in the switching circuit 10. The reference transceiver may also be placed outside of the temperature control chamber 30.

As yet a further example, the temperature control chamber 30 may also be automatically controlled via the host computer 8.

1. A testing apparatus for obtaining a parameter of an opto-electronic device under test (DUT), the apparatus comprising:
a reference device from which at least one calibration value has been obtained; and
a storage medium for storing the at least one calibration value;
wherein the reference device is optically coupleable to the DUT whereby a light signal can be caused to propagate between the reference device and the DUT and generate an output signal that provides the desired parameter according to the stored at least one calibration value.

2. A testing apparatus according to claim 1, wherein the light signal is transmitted from the reference device to the DUT at a power level determined by the stored at least one calibration value and the parameter, corresponding to the power level, is obtained from an output signal of the DUT.

3. A testing apparatus according to claim 2, wherein the at least one calibration value comprises at least one bias current configuration value for setting a bias current of the reference device to thereby cause the reference device to generate a light signal at at least one known power level corresponding to the at least one bias current configuration value.

4. A testing apparatus according to claim 3, wherein the at least one parameter of the DUT comprises at least one of a receiver signal detect voltage level, a receiver power assert level, a receiver power deassert level, a receiver data swing and a receiver data bar swing of the DUT.

5. A testing apparatus according to claim 3, wherein the at least one calibration value further comprises at least one modulation current configuration value corresponding to the bias current configuration value, the modulation current configuration value being for setting a modulation current of the reference device to maintain the extinction ratio (ER) of a light signal generated using the bias current configuration value at least substantially at a predetermined ER value.

6. A testing apparatus according to claim 5, wherein the at least one parameter of the DUT comprises a receiver center sensitivity of the DUT, wherein the receiver center sensitivity is the power level of light transmitted by the reference device that is received by the DUT at a bit error rate (BER) at which the receiver center sensitivity is to be obtained.

7. A testing apparatus according to claim 1, wherein the light signal is transmitted from the DUT to the reference device and the parameter is obtained from an output signal of the reference device according to the stored at least one calibration value.

8. A testing apparatus according to claim 7, wherein the at least one calibration value comprises a plurality of bit error rate (BER) values that correspond to light received by the reference device at known respective power levels.

9. A testing apparatus according to claim 8, wherein the at least one parameter of the DUT comprises a transmitter light output power (LOP) of the DUT that is given by a power level corresponding to the BER value of the output signal of the reference device.

10. A testing apparatus according to claim 9, wherein an optical modulation amplitude (OMA) of a received light signal is determinable and readable from the reference device.

11. A testing apparatus according to claim 10, wherein the at least one parameter of the DUT further comprises a transmitter OMA that is obtainable by receiving light transmitted by the DUT and reading the OMA of the received light from the reference device.

12. A testing apparatus according to claim 11, wherein the at least one parameter of the DUT further comprises a transmitter extinction ratio (ER), the transmitter ER being obtainable based on the transmitter OMA and the transmitter LOP.

13. A testing apparatus according to claim 1, wherein the at least one calibration value comprises a plurality of temperature-dependent calibration values.

14. A testing apparatus according to claim 1, further comprising a temperature control chamber that houses the reference device and the DUT coupleable to the reference device so that the parameter of the DUT is obtainable at at least one predetermined temperature.

15. A testing apparatus according to claim 14, further comprising at least one additional reference device in the temperature control chamber, each additional reference device being coupleable to a respective additional DUT.

16. A testing apparatus according to claim 15, further comprising:
at least one test and measurement instrument;
a switching circuit; and
a processor adapted to configure the switching circuit to connect the test and measurement instrument to a selected pair of reference device and DUT for measuring its output signal and control the selected pair of reference device and DUT to cause a light signal to propagate therebetween.

17. An apparatus according to claim 1, wherein the opto-electronic device under test (DUT) is an opto-electronic transceiver and the reference device is a reference transceiver that is at least substantially of the same type as the DUT.

18. A method of obtaining at least one parameter of at least one opto-electronic device under test (DUT), the method comprising:
calibrating at least one reference device to obtain at least one calibration value;
storing the at least one calibration value in a storage medium;
coupling the DUT to the reference device;
if the parameter is a receiver parameter,
configuring the reference device using the at least one calibration value to transmit a light signal of a corresponding known power level to the DUT; and
measuring an output signal of the DUT to obtain the receiver parameter; and
if the parameter is a transmitter parameter,
configuring the DUT to transmit a predetermined light signal to the reference device;
measuring an output signal of the reference device; and
obtaining the transmitter parameter from the at least one calibration value based on the measurement.

19. A method of obtaining at least one parameter from each of a plurality of opto-electronic devices under test (DUTs) comprising:
calibrating a plurality of reference devices at a predetermined temperature to obtain at least one calibration value associated with each such reference device;
storing the calibration values in a storage medium;
coupling each reference device to an associated DUT;
placing the plurality of reference devices and the plurality of associated DUTs in a temperature control chamber;
setting the temperature of the chamber to the predetermined temperature;
if the parameter is a receiver parameter, using the stored calibration values to configure the associated reference devices to transmit light signals to the associated DUTs, each light signal having substantially the same known power level as the other light signals, and measuring an output of each DUT to obtain the receiver parameter for that DUT;
if the parameter is a transmitter parameter, configuring each DUT to transmit a predetermined light signal to its associated reference device, measuring the output of each reference device, and obtaining the transmitter parameter from the measured output according to the at least one calibration value associated with that reference device.

20. A method according to claim 19 wherein measuring an output of each DUT comprises sequentially connecting at least one test and measurement instrument to each DUT and wherein measuring an output of each reference device comprises sequentially connecting at least one test and measurement instrument to each reference device.
